(19) United States
(12) Patent Application Publication
(10) Pub. No.: US 2012/0175192 A1
(43) Pub. Date: Jul. 12, 2012

(54) Elevator Control System

(75) Inventor: Chia-Chun Tsou, Jhonghe City (TW)

(73) Assignee: UTECHZONE CO., LTD., Jhonghe City (TW)

(21) Appl. No.: 13/004,142

(22) Filed: Jan. 11, 2011

(51) Int. Cl. B66B 1/00

(52) U.S. Cl. 187/247

(57) ABSTRACT

An elevator control system installed in an elevator includes a camera device for capturing an image of a user in the elevator; a detecting device coupled to the camera device for detecting a hand in the image and a request option from the user; and a processing unit coupled to the camera device for executing the request option from the user to control and operate the elevator.

### BACKGROUND OF THE INVENTION

1. Field of the Invention

The present invention relates to a control system, and more particularly to an elevator control system operated in a remote and aseptic way.

2. Description of the Related Art

As our society and lifestyle are changed, high-rise buildings are everywhere and elevators have become one of the most important equipments of the high-rise buildings. People can go to any floor of the high-rise building quickly and easily by the back-and-forth movement of the elevator.

In general, the elevator is controlled to move to a certain floor according to an input switch of the floor and then opens the door to allow passengers to enter into the elevator. The passengers in the elevator can go to their desired floor by pressing an input switch installed in the elevator.

If the elevator is crowded with people, it is difficult and inconvenient for passengers to press the input switch in order to go to their desired floor. Furthermore, various infectious diseases such as severe acute respiratory syndrome (SARS) and enterovirus occur and spread constantly. People are scared of the contacting infections of such diseases. However, an elevator is ridden by a certain number of passengers and its input switches pressed by passengers become a breeding ground of the contacting infections. Since germs, viruses or bacteria are attached on the input switches, the passengers may be infected easily when they touch the input switches, particularly for the input switches of the elevators in a hospital. Except washing our hands frequently, there is no other better solution to this problem.

### SUMMARY OF THE INVENTION

In view of the aforementioned problem, the present invention provides an elevator control system, such that a passenger can select a desired floor by a hand posture (gesture), and the hand postures of different passengers can be processed one by one, so that the elevator can be operated smoothly.

To achieve the foregoing objective, it is a primary objective of the present invention to overcome the aforementioned problem by providing an elevator control system with a remote control function, such that a user does not need to pass through other users to operate the input switch, and many users can operate the input switch at the same time, so as to improve the convenience of operation when many users are riding the elevator. In addition, the present invention can prevent contacting infections caused by touching the input switches which have been pressed by fingers of other users.

An elevator control system in accordance with a preferred embodiment of the present invention is installed in an elevator and comprises a camera device for capturing an image of a user in the elevator, a detecting device coupled to the camera device for detecting a hand in the image and a request option from the user, and a processing unit coupled to the detecting device for executing the request option from the user to control and operate the elevator. Obviously, the present invention can improve the convenience of selecting a floor or executing other functions.

### BRIEF DESCRIPTION OF THE DRAWING

FIG. 1 is a block diagram of an elevator control system in accordance with a preferred embodiment of the present.

### DETAILED DESCRIPTION OF THE PREFERRED EMBODIMENTS

The foregoing and other objectives, characteristics, and advantages of the present invention will become apparent by the detailed description of a preferred embodiment together with the illustration of related drawings as follows.

The present invention provides an elevator control system capable of processing hand postures of different users for selecting the users' desired floors, and avoiding a direct contact with input switches of the elevator to prevent contacting infections.

To achieve the aforementioned effect, the present invention provides an elevator control system in accordance with a preferred embodiment, which is installed in an elevator, and the elevator control system comprises a camera device for capturing an image of a user in the elevator, a detecting device coupled to the camera device for detecting a hand in the image and a request option from the user, and a processing unit coupled to the detecting device for executing the request option from the user to control and operate the elevator, so that the present invention can improve the convenience of selecting a floor or executing other functions.

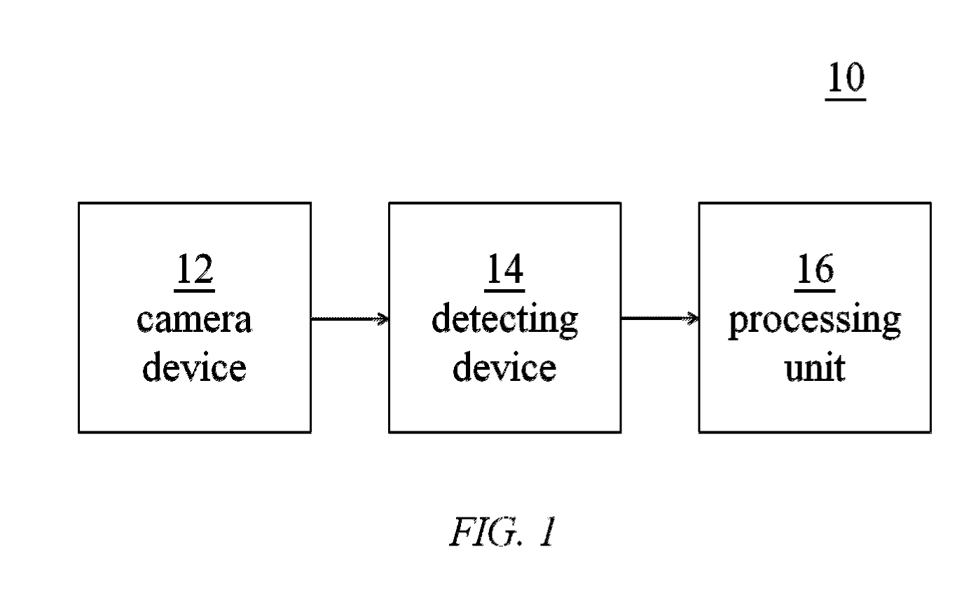

With reference to FIG. 1 for a block diagram of an elevator control system in accordance with a preferred embodiment of the present invention, the elevator control system 10 is installed in an elevator and comprises a camera device 12, a detecting device 14, and a processing unit 16.

In this preferred embodiment, the camera device 12 is a charged coupled device (CCD) camera. The camera device 12 includes a flash accessory device. The flash accessory device, such as the lighting in the elevator, can improve the quality of the images captured by the camera device 12 and the recognition rate, so as to enhance the accuracy of the image recognition. After an image is captured by the camera device 12 in the elevator, the image is transmitted to the detecting device 14 coupled to the camera device 12.

Through the visual image processing, the detecting device 14 is provided for detecting a hand in the captured image. After images other than the hand are filtered and removed, the image feature detection is performed according to the hand in the captured image to detect the hand posture of the user who selects a floor, so as to generate a request option correspondingly. Each hand posture corresponds to a floor or a functional option such as opening the door of the elevator or closing the door of the elevator, which is defined by the elevator control system.

The detecting device 14 determines the floor or functional option selected by the user's hand posture and transmits the determination result to the processing unit 16 for controlling and operating the elevator according to the user's request option. Therefore, users can execute the selection of a floor or a functional option directly without pressing any input switch, and thus the present invention can improve the convenience of operating the elevator.

In addition, the present invention also allows many users to select their desired floor at the same time. When the elevator is crowded, users may select their desired floor by the hand posture at the same time, and the hand feature detected by the detecting device 14 can be captured and compared one by one to control and operate the elevator smoothly, so as to overcome the inconvenience or problem of unable to press the input switches in a crowded elevator.

In summation of the description above, the present invention compares images of the hand postures with reference image data to determine the correspondence of the hand posture to the reference image data, and the reference image data correspond to the floors or functional options, respectively. Therefore, users can select a floor or a functional option by posing a hand posture in front of the camera device 12 in the elevator. Obviously, the present invention is very convenient. The present invention can also avoid a direct contact of the input switch pressed by users, prevent the contacting infections, and overcome the potential risk of being infected by viruses or bacteria.

While the present invention has been described by means of a specific embodiment, numerous modifications and variations could be made thereto by those ordinarily skilled in the art without departing from the scope and spirit of the present invention set forth in the claims.

What is claimed is:

1. An elevator control system, installed in an elevator, and comprising:
a camera device, for capturing an image of a user in the elevator;
a detecting device, coupled to the camera device, for detecting a hand in the image and a request option from the user; and
a processing unit, coupled to the detecting device, for executing the request option from the user to control and operate the elevator.

2. The elevator control system of claim 1, wherein the camera device is a charged coupled device (CCD) camera.

3. The elevator control system of claim 1, wherein the camera device includes a flash accessory device.

4. The elevator control system of claim 1, wherein the detecting device filters and removes the image other than a hand image.

5. The elevator control system of claim 4, wherein the detecting device performs an image feature detection of the hand image to detect a hand posture of the user who selects a floor.

6. The elevator control system of claim 5, wherein each said hand posture corresponds to a floor.

7. The elevator control system of claim 5, wherein each said hand posture corresponds to a functional option defined by the elevator control system.

8. The elevator control system of claim 7, wherein the functional option is to open the door of the elevator.

9. The elevator control system of claim 7, wherein the functional option is to close the door of the elevator.
